(19) United States
(12) Patent Application Publication
(10) Pub. No.: US 2014/0159399 A1
(43) Pub. Date: Jun. 12, 2014

(54) MULTIPLE USE RETRIEVING AND INSERTING DEVICES

(71) Applicant: Charles A. Peralo, Rock Hill, NY (US)

(72) Inventor: Charles A. Peralo, Rock Hill, NY (US)

(21) Appl. No.: 13/708,170

(22) Filed: Dec. 7, 2012

(51) Int. Cl. A63B 47/02; B25J 15/12

(52) U.S. Cl. CPC A63B 47/02; B25J 15/12
USPC 294/19.2; 294/99.2

(57) ABSTRACT

A device for capturing an object includes a base and a plurality of resilient fingers extending from the base. The fingers provide an internal space for accepting at least a portion of the object, wherein the distal ends of the fingers define an opening configured to deflect the fingers outwardly to enlarge the opening when the object passes through it. An elastic member is attached between plural fingers, and exerts essentially no inward force resisting expansion of the internal space until the fingers are deflected outwardly, such as by the object. Various forms of the device enable it to be used and/or easily adapted for use in many settings, including a light bulb changer that can reach remote locations and is adaptable to many different bulb shapes and sizes, and a sports ball holder/retriever, a device for freeing an object from an attachment at a remote location and retrieving it.

### BACKGROUND OF THE INVENTION

1. Field of the Invention

The present invention relates generally to devices for gripping remote objects, and more particularly, to gripping devices suitable for retrieving a variety of objects and/or placing objects at remote locations.

2. Description of Related Art

There are many circumstances in which an object must either be retrieved from or placed in a generally inaccessible remote location. Examples are a golf ball in a water hazard and a light bulb in a high ceiling. In the former case, there are many instances in which a golfer can see his or her ball in a water hazard, but it is out of reach without some sort of implement. The latter case presents the necessity of removing a burned out light bulb and replacing it with a new one. Light bulbs mounted in a high ceiling cannot be reached without some sort of assistance, be it a ladder or an implement.

Taking golf balls first, there are hundreds, if not thousands, of golf ball retrievers known to the prior art. For present purposes, they can be considered in two groups. One scoops the ball into a receptacle at the end of a rod as the receptacle is passed beneath the ball and then raised to capture the ball. This type of device has an advantage in its simplicity of construction, but it also has drawbacks. If the golf ball is in a water hazard, scooping underneath it usually stirs up sediment on the bottom of the hazard. Even if great care is taken, this can obscure the ball before it can be captured in the receptacle. In addition, the ball can also float out of the receptacle as it is being retrieved. There have been attempts to mitigate some of the drawbacks of this type of device, but an improved approach would still be welcome. Another drawback to this type of device is that it requires being able to position the receptacle under the ball, which is not always possible in a water hazard, not to mention other circumstances when the ball can be seen but not reached by hand.

Another type of ball retrieval device has a ball receptacle that is pressed down on the ball from above. Examples of one form or other of this kind of device are shown in the following patents and publications:

| U.S. Pat. No. 1,658,145 | U.S. Pat. No. 4,846,515 | U.S. Pat. No. |
|---|---|---|
| | | 7,311,345 |
| U.S. Pat. No. 2,551,486 | U.S. Pat. No. 5,277,466 | U.S. Pat. No. |
| | | 7,384,347 |
| U.S. Pat. No. 3,136,573 | U.S. Pat. No. 5,303,967 | U.S. Pat. No. |
| | | 7,645,200 |
| U.S. Pat. No. 3,401,970 | U.S. Pat. No. 5,326,145 | U.S. Pat. No. |
| | | 7,938,465 |
| U.S. Pat. No. 3,462,184 | U.S. Pat. No. 5,437,488 | Pub. No. US |
| | | 2009/0033109 |
| U.S. Pat. No. 4,046,413 | U.S. Pat. No. 5,460,366 | GB Appln. No. |
| | | 10,601 |
| U.S. Pat. No. 4,334,707 | U.S. Pat. No. 6,971,695 | UK Appln. No. GB |
| | | 2,271,937 |

One kind of this device uses spring fingers that must be pushed apart to admit the ball, after which the fingers form a cage around the ball. A drawback of this kind of device is that in a water hazard, pushing down on the ball to separate the fingers may instead just push the ball into the soft, muddy bottom typical of most such hazards, thus losing the ball permanently. An example of this type of retriever is shown in U.S. Pat. No. 7,384,347. It has a rubber band that biases the fingers together, but it is intended to retrieve balls from the ground or from the cup after holing out, so the downward force required to separate the fingers is not a concern. U.S. Pat. No. 6,123,282 shows a device constructed similarly to some golf ball retrievers, but designed for a different purpose. This device has fingers urged together by a spring around their distal ends for gripping a baseball and enabling the user to extend it for an autograph. In this device the user places the ball between the fingers manually, so it is not a retrieval device per se. Nevertheless, even if it were used as a retrieval device, the force required to separate the fingers would give rise to the same drawbacks as the devices in the other patents specifically intended for retrieving golf balls in remote, otherwise inaccessible locations.

Another device that permits manipulation of remote and otherwise inaccessible objects is a remote light bulb changer. It is not known that this type of device has heretofore been considered as having any relation to ball retrieval devices. However, they do have certain operational characteristics in common, such as accessing and, retrieving a remote, generally spherical or ovoid object, although a light bulb changing device also must hold the light bulb firmly enough to enable it to be screwed out of and into a remote socket.

As with prior ball retrievers, a popular light bulb changing device known in the prior art uses spring fingers that must be pushed apart to admit the bulb, after which the fingers grip the bulb tightly enough for screwing it out of or into a light socket. Examples of this kind of device are shown in the following patents and publications:

| | | |
|---|---|---|
| U.S. Pat. No. 431,721 | U.S. Pat. No. 1,926,948 | U.S. Pat. No. |
| | | 6,223,628 |
| U.S. Pat. No. 1,823,170 | U.S. Pat. No. 2,526,084 | Pub. No. US |
| | | 2006/0162502 |
| U.S. Pat. No. 1,056,084 | U.S. Pat. No. 2,556,701 | JP No. 3-149157 |
| U.S. Pat. No. 1,157,617 | U.S. Pat. No. 2,681,822 | |
| U.S. Pat. No. 1,202,432 | U.S. Pat. No. 2,766,060 | |

One drawback of such devices is the force that the spring fingers must exert on the bulb to permit it to be screwed out of a socket. Even with non-slip surfaces on the interior of the fingers, the force can be sufficient in some instances to break the bulb. For the same reason, a particular device designed for a certain size of bulb can only accept bulbs of different sizes within a narrow range. That is, a given finger spacing for a smaller bulb sizes could only be used with slightly larger bulbs because the compressive force exerted on a larger bulb could break it. Moreover, light bulbs come in many different shapes as well as sizes, and the spring-finger paradigm is not particularly suited to different shapes of bulbs. For example, an old-style incandescent bulb would require different shaped fingers or a different number of fingers than a spotlight or floodlight, and a bulb changer for compact fluorescent lights might require still differently shaped fingers altogether.

Finally, an insight leading to another aspect of the present invention described below is that a retrieval device can be provided with certain constructional characteristics in common with a light bulb changing device and golf ball retriever, and can also be further adapted to retrieve objects that are attached at a remote location by remotely severing the attachment. Such a device could be used for harvesting fruit, for example, and there is no known device that uses this approach to such an end.

### SUMMARY OF THE INVENTION

It is an object of the present invention to provide a variety of remote retrieval devices with common constructional characteristics that adapt them fir multiple uses and that overcome difficulties with prior art single-use devices.

It is another object of the invention to provide a device in which common constructional features enable it to be used and/or easily adapted for use as both a light bulb changer that prevents damage to the light bulb and is adaptable to many different bulb shapes and sizes, and a golf ball retriever that provides a way to retrieve the ball from areas where scooping it up or pushing it down complicates retrieval. Further, with only minor variations, the same basic construction can be used in a device for freeing an object from an attachment at a remote location and retrieving the object after it has been freed. Other variations and constructions provide devices for holding and retrieving objects in numerous other situations.

In accordance with one aspect of the invention a device for capturing an object comprises a base, as plurality of resilient fingers extending from the base, the fingers being configured to provide an internal space for accepting therein at least a portion of the object, wherein the distal ends of the fingers define an opening configured to deflect the fingers outwardly to enlarge the opening when the object is passed therethrough, and at least one elastic member attached between plural fingers, wherein the elastic member exerts an inward force resisting expansion of the internal space only when the fingers are deflected outwardly. This aspect of the invention has a variety of preferred forms.

In one preferred form the fingers each have a proximal end attached to the base and a distal end, the distal ends of the fingers being substantially evenly spaced around the space, and each of the fingers includes a portion between its proximal and distal ends that is bowed outwardly so that the cross sectional area of the opening is less than the cross sectional area of the space at the bowed portion of the fingers, with an elastic member that includes an elastic mesh enclosing the space at least at the bowed portion of the fingers, wherein the elastic mesh is expanded when the object is in the space for gripping the object. In another preferred form the elastic member comprises an elastic band attached to and surrounding the opening at the distal ends of the fingers and a generally tubular elastic mesh with one edge attached to the fingers at a location between the distal ends of the fingers and the bowed portion and another edge attached to the fingers at a location between the bowed portion and the base. In still another preferred form the elastic member is an elastic band attached to and surrounding the opening at the distal ends of the fingers. In yet another preferred form the fingers each have a proximal end attached to the base and a distal end, the distal ends of the fingers being substantially evenly spaced around the space, and one of the fingers comprises adjacent first and second finger parts to which the elastic member is attached to provide an open channel between the finger parts

In accordance with another aspect of the invention a device for retrieving a golf ball comprises a base including a mount for permitting a user to adjust an angle formed between the base and a handle attached to the base, a plurality of fingers, each having a proximal end attached to the base and a distal end, the fingers defining an internal space with an opening formed by the distal ends of the fingers for permitting the golf ball to enter the space, wherein the fingers substantially retain their original shape as the golf ball passes through the opening and the internal space has a cross sectional area at least as large as the diameter of the golf ball, and at least one unexpanded elastic member surrounding the opening at the distal ends of the fingers, wherein the elastic member expands as the golf ball passes through the opening and resumes its original unexpanded shape when the golf ball is within the space.

In another aspect of the invention a collapsible device for capturing an object comprises a first frame member having at least two struts with proximal ends attached to a mounting portion with a space between the struts and a second frame member having at least two struts with proximal ends attached to a mounting portion with a space between the struts, the mounting portions being pivotably mountable to a base for rotation between a stowed position wherein the struts lie against the base and a deployed position wherein the struts extend upright from the base, a first spring biasing the first frame member into the deployed position and a second spring biasing the second frame member into the deployed position, wherein when the frame members are in the deployed positions the struts provide an internal space for accepting therein at least a portion of the object and the distal ends of the struts define an opening for accepting the object, at least one elastic member attached to the distal ends of the struts for retaining the object when the frame members are in the deployed positions, and a retainer for releasably retaining the frame members in the stowed positions. One preferred form of the device includes the base with the frame members mounted thereto, and the base includes an attachment for securing the base to the end of a handle of a golf club and has the retaining clip thereon.

This Summary is provided to introduce in a simplified form a selection of concepts relating to the subject matter described herein that are further described below in the Detailed Description of Preferred Embodiments. It is not intended necessarily to identify key or essential features of the invention, nor as an aid in determining the scope of the claimed subject matter.

### BRIEF DESCRIPTION OF THE DRAWINGS

The objects of the invention are not limited by the description above, and all of the objects and advantages of the invention will be better understood from the detailed description of its preferred embodiments which follows below, when taken in conjunction with the accompanying drawings, in which like numerals and letters refer to like features throughout. The following is a brief identification of the drawing figures used in the accompanying detailed description.

FIG. 1 is an isometric view of a first embodiment of a multiple use retrieving and inserting device with an elastic mesh holding member that can be used to change light bulbs, retrieve golf balls and other sports balls, place and retrieve Christmas ornaments, pick fruit, and other environments involving manipulating remote objects.

FIGS. 2A and 2B are isometric views of the first embodiment of the device with respective different types of light bulbs held in the device. (FIGS. 2A and 2B together are sometimes referred to herein as FIG. 2.)

FIG. 3 is an isometric view of a modified version of the device shown in FIGURE with a different elastic mesh holding member.

FIGS. 4 and 5 are isometric views of further modified versions of the device FIG. 1 with respective different elastic mesh holding members.

FIG. 6 is an isometric view of a still further modified version of device shown in FIG. 1.

FIG. 7 is an isometric view of a version of the device shown in FIG. 1 specially adapted for use as a golf ball retriever, and showing details of an arrangement for adjustably mounting the device to an elongated handle.

FIG. 8 is an isometric view of the device shown in FIG. 7 with a base that can be attached to the grip of a golf churl:

FIG. 9 is an isometric view of a version of the device shown in FIGS. 7 and 8, modified to hold a baseball, and having a base that can be attached to the handle of a baseball bat.

FIG. 10A is an isometric view of another embodiment of a device adapted for use as a golf ball retriever; FIG. 10B illustrates the device holding a golf ball. (FIGS. 10A and 10B together are sometimes referred to herein as FIG. 10.)

FIG. 11 is an isometric view of a modified version of the device shown in FIG. 1 specially adapted for capturing a remote object such as fruit attached to a tree and severing the stem so that the fruit can be harvested.

FIG. 12 is an isometric view of a modified version of the device shown in FIG. 11.

FIGS. 13 and 14 are isometric views of still further modified versions of the devices shown in FIGS. 11 and 12.

FIG. 15, comprising FIGS. 15A and 15B, shows a collapsible device according to another aspect of the invention constructed for attachment to a sports implement such as a golf putter for holding the ball used in the sport in a deployed configuration holding a golf ball. FIG. 15A shows the device in deployed configuration and FIG. 15B shows the same device in a stowed configuration.

One skilled in the art will readily understand that the drawings are not strictly to scale, but nevertheless will find them sufficient, when taken with the detailed descriptions of preferred embodiments that follow, to make and use the present invention.

### DETAILED DESCRIPTION OF EXEMPLARY EMBODIMENTS

The detailed description that follows is intended to provide specific examples of particular embodiments illustrating various ways of implementing the claimed subject matter. It is written to take into account the level of knowledge of one of ordinary skill in the art to which the claimed subject matter pertains. Accordingly, certain details may be omitted as being unnecessary for enabling such a person to realize the embodiments described herein. It will also be understood that terms indicating direction or orientation, such as “lower,” “upper,” “top,” “bottom,” etc., may be used to facilitate the description of these exemplary embodiments. The use of such terms does not imply that the claimed subject matter is limited to a particular orientation of the structure being described. When introducing elements of various embodiments of the present invention, the articles “a,” “an” and “the,” and the word “said,” are intended to mean that there are one or more of the elements. The terms “comprising,” “including,” and “having” are intended to be inclusive and mean that there may be additional elements other than those listed or specifically mentioned. Moreover, while the term “exemplary” may be used herein in connection with certain examples of aspects or embodiments of the presently disclosed technique, it will be appreciated that these examples are illustrative in nature and that the term “exemplary” is not used herein to denote any preference or requirement with respect to a disclosed aspect or embodiment.

In addition, certain embodiments of the invention have features that are similar or generally correspond in structure or function, or both, to features in other embodiments, although the features may not be strictly identical from one embodiment to another. Such features are typically introduced with a particular reference numeral, and then identified in subsequently described embodiments with the same reference numeral using a prime (′) symbol, or sometimes multiple prime symbols. This is done strictly by way of convenience for the reader, to facilitate identifying similar features in different embodiments, and is not meant to be in any way limiting as to the forms such features may take in the different embodiments. In addition, a primed feature in a drawing figure may not be explicitly described in the text, it being understood that the feature corresponds in the fashion just described to the previously described feature bearing the same reference numeral.

### Multi-Use Device

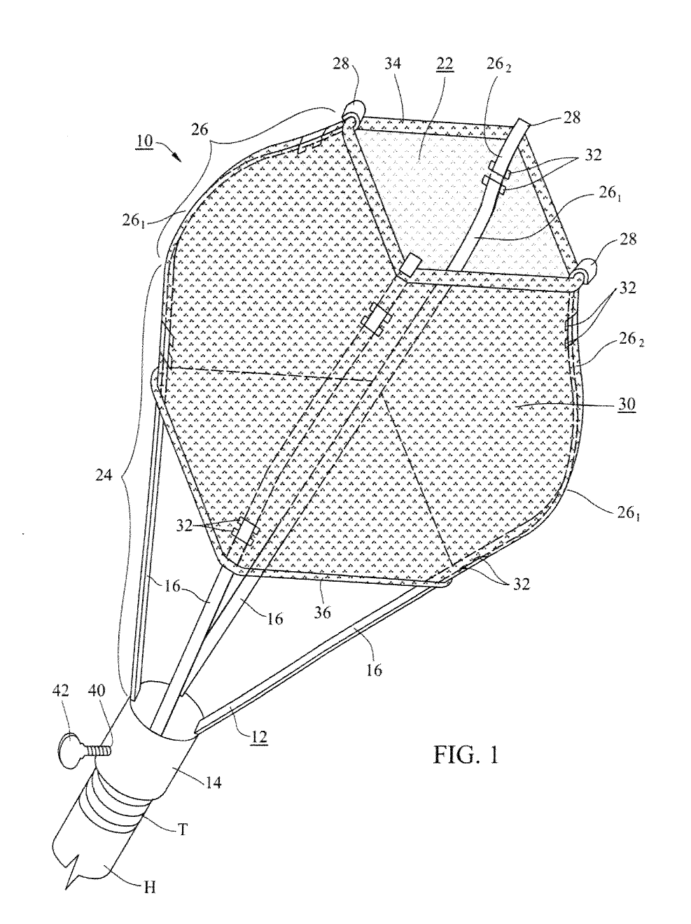

FIG. 1 is an isometric view of a gripper device 10 according to a first embodiment of the invention that can be usable in multiple applications, such as a ball retriever or a light bulb changer. It can also be used as is or in modified form to place and retrieve Christmas ornaments, pick fruit, and or any other application in which an object needs to be placed in or retrieved from a location not immediately accessible. It will be understood that the configuration and construction in FIG. 1 is exemplary in many respects and variations are possible to adapt the device to different applications. Some of those variations are described herein in connection with alternate embodiments. For example, different mounting arrangements described herein adapt the device to uses in different environments.

The exemplary device 10 in FIG. 1 includes a frame 12 that comprises a base 14 and a cage comprising four resilient fingers 16 secured to it. In a preferred embodiment the fingers are identical for ease of manufacture, but they may be different if it would be more appropriate to the application of the device. The fingers are attached securely to the base 14 in any suitable fashion and extend upwardly therefrom. The fingers 16 thus form a cage-like internal space 22 that can enclose an object in a fashion described further below. The fingers are evenly spaced in a circumferential direction, so that if there are four fingers, as in the embodiment shown in FIG. 1, the fingers are at 90° relative locations around the periphery of the space 22. The number and relative spacing of the fingers is optional, although the device will typically include at least four fingers. Larger devices may require more fingers to provide the necessary gripping action described below during use of the device. By the same token, other devices may have only three fingers. The fingers can be made of any suitable resilient material, such as spring steel, aluminum, plastic, etc. The base 14 can be metal or molded plastic and the fingers can be attached to the base by adhesive, suitable fasteners (not shown), a combination thereof, or in any other manner that rigidly secures the fingers 16 in place to the base 14. The base 14 and the fingers 16 may also be molded in one piece from a suitable plastic material.

In the embodiment shown in FIG. 1, each finger 16 has a straight portion 24, a proximal end of which attaches to the base 14. The distal end of the straight portion 24 of each finger smoothly transitions into a curved portion 26 that has a compound curvature with a bowed concave portion 26₁ (as viewed from inside the space 22) followed by an slightly outwardly flared portion 26₂ that terminates at the distal end of the respective finger. The flared portion facilitates entry of the object to be gripped into the distal end of the space 22 in a manner that will be clearer as this description proceeds. The distal end of each finger 16 includes an outwardly facing hook 28. The curvature of the fingers provides the space 22 with a portion that is bowed outwardly between the fingers' proximal and distal ends. The bowed portion of the space 22 is surrounded by an elastic member, which in the present embodiment is a mesh enclosure 30, a preferred form of which is elastic netting or mesh. The enclosure is attached to the fingers and conforms to the shape of the space 22. The elastic mesh enclosure 30 can be attached to the fingers 16 in any suitable fashion. In the illustrated embodiment, the distal ends of the fingers 16 are inserted through pairs of slits 32 in the mesh as it is fed downwardly over the fingers 16, with the elasticity of the mesh facilitating the process. The top edge of the netting has a rolled hem 34 that is accepted into the hooks 28 to assist in holding the mesh in place at the top opening to the space 22. The bottom edge of the mesh will typically also have a rolled hem 36 to lend shape to the mesh, assist in keeping it in place on the fingers 26, and grip larger objects that extend deeper into the space 22. Those skilled in the art will recognize that the mesh can be held more securely in place by additional fastening arrangements, such as cooperating snaps on the fingers and the mesh, or cooperating Velcro® strips adhered to the fingers and sewn into or otherwise attached to the mesh. Those skilled in the art will appreciate that any other manner of mounting the mesh to the fingers whatsoever (an adhesive, rivets, etc.) can also be used, as long as it does not interfere with the function and operation of the device according to the description herein.

The base 14 is detachably secured to a pole H, which in a preferred form will telescope in a conventional fashion so that it may be extended and retracted to match the distance to the object with which the device is to be used (such as a light bulb in a high ceiling). Details of the telescoping structure of the pole are omitted because they are conventional and well understood to those skilled in the art. Examples of poles suitable for this purpose, with telescoping sections secured against relative axial rotation, are shown in the above-listed U.S. Pat. No. 1,823,170 and U.S. Pat. No. 6,223,628, the disclosures of which are incorporated herein by reference. The pole H has external threads T at its distal end that are accepted into mating internal threads (not shown) in an opening extending axially into the bottom of the base 14. The base includes a threaded hole 40 extending radially from the outside circumferential surface of the base and into the axial opening that accepts the threads T on the end of the pole H. A thumbscrew 42 screws into the hole 40 so that the user of the device can tighten the internal end of the thumbscrew into contact with the pole H to prevent relative rotation of the base 14 and the pole H. Accordingly, a user holding the proximal end of the pole H (not shown) can exert torque around an axis of the device 10, in a fashion that will be described in more detail below. Those skilled in the art will understand that the connection between the device 10 and a user handle (such as the pole H) can take any suitable form, and the threaded connection secured against rotation by a thumbscrew depicted in the drawings herein is merely an example of a suitable connection. For example, the pole H and the base 14 could be an integral unit in this or other embodiments described below.

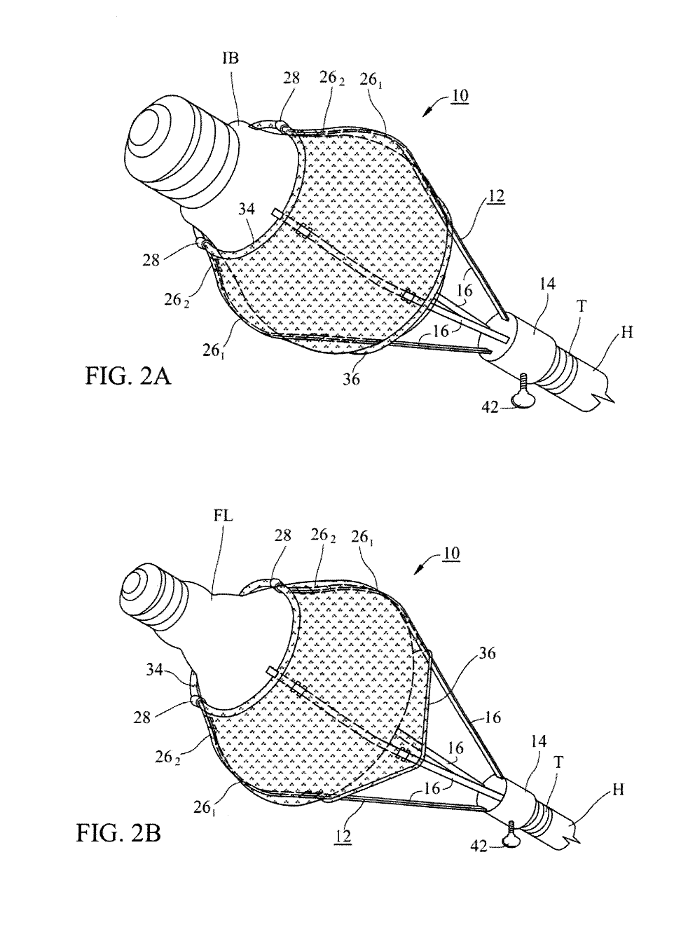

FIGS. 2A and 2B illustrate how the gripper device of the present embodiment can be used with different shaped objects. FIG. 2A illustrates the gripper device 10 in use with an incandescent light bulb IB within the space 22 formed by the fingers 16. An important feature of this embodiment of the invention resides in the configuration of the mesh enclosure 30, namely that when there is no object in the space 22, the fingers exert little or no tension on the mesh enclosure 30, and that the fingers 16 accordingly have little or no inward force exerted on them by the mesh. In other words, the unstretched shape of the mesh 30 essentially matches the shape of the space 22, and the mesh would look virtually the same as it does in FIG. 1 even if it were not mounted on the fingers. In other words, the mesh can be made so that it exerts an inward force on the fingers, say, to assist in holding it in place, but such inward force is kept to a minimum to permit the object to easily bend the fingers 16 and force them apart when their distal ends are pressed against the object. The outwardly flared portions 26₂ of the fingers 16 permit the object to slip into the space 22, assisted by the rolled hem 34 at the top edge of the mesh enclosure, even though the bulb is larger than the opening formed at the top of the space 22 by the hem 36 in the hooks 28. Since the concave portions 26₁ of the fingers are shaped so that they generally conform to the shape of the object to be gripped, here the bulb IB, the fingers may be bent slightly outwardly by the object when it is in place as in FIG. 2A, but in a preferred form of the device the object does not substantially deform the fingers. It will be appreciated that bulb is captured in the internal space because the bowed portions of the fingers between their proximal and distal ends provide a cross sectional area that is larger than the cross sectional area of the opening formed by the distal ends of the fingers.

Although the fingers are configured only to gently grip the bulb, thereby minimizing the likelihood of breaking it, the mesh enclosure is able to exert a torque sufficient to screw or unscrew the bulb into or out of a light socket. This can be appreciated by a comparison of the shape of the mesh 30 in FIG. 1 with the shape into which it is stretched by the bulb IB in FIG. 2A. In FIG. 1 the mesh surface assumes a straight line between adjacent fingers 16, but in FIG. 2A the mesh between the fingers is expanded and curved outwardly by the bulb IB. In addition, the mesh extends along the fingers from the hooks 28 toward the base 14 a sufficient distance to cover all or a substantial portion of the surface of the bulb IB. FIG. 2A illustrates a situation in which the bulb IB reaches to the bottom hem 36, but in which there is still substantial mesh area in contact with the bulb surface. In this fashion the surface-to-surface contact area between the mesh and the bulb provides sufficient torque on the bulb as the user rotates the pole H to loosen it from or tighten it into a socket, while exerting a very small compressive force on the bulb.

The torque applied by the mesh 30 can be enhanced by treating its inner surface to increase the friction between it and the surface of the bulb. One convenient way of enhancing the frictional force on the bulb would be to rubberize the surface of a fabric mesh, or use rubber netting as the mesh itself. Open netting is a particularly advantageous form for the mesh 30 in many applications, since it will readily expand to accept objects within the space, and provide a better view of the object when it is within the space. Those skilled in the art will recognize many other ways of providing additional frictional engagement between the mesh and a light bulb in the application shown in FIG. 2A. For example, the interior of the mesh or netting could have longitudinal ribs extending from top to bottom at circumferentially spaced intervals along the mesh internal surface, or dimples and/or studs could be provided over a substantial portion of the mesh internal surface. Those skilled in the art will recognize that many other surface treatments or configurations will be possible within the scope of the invention, and that such surface treatments or particular mesh materials can be used with any of the embodiments described herein.

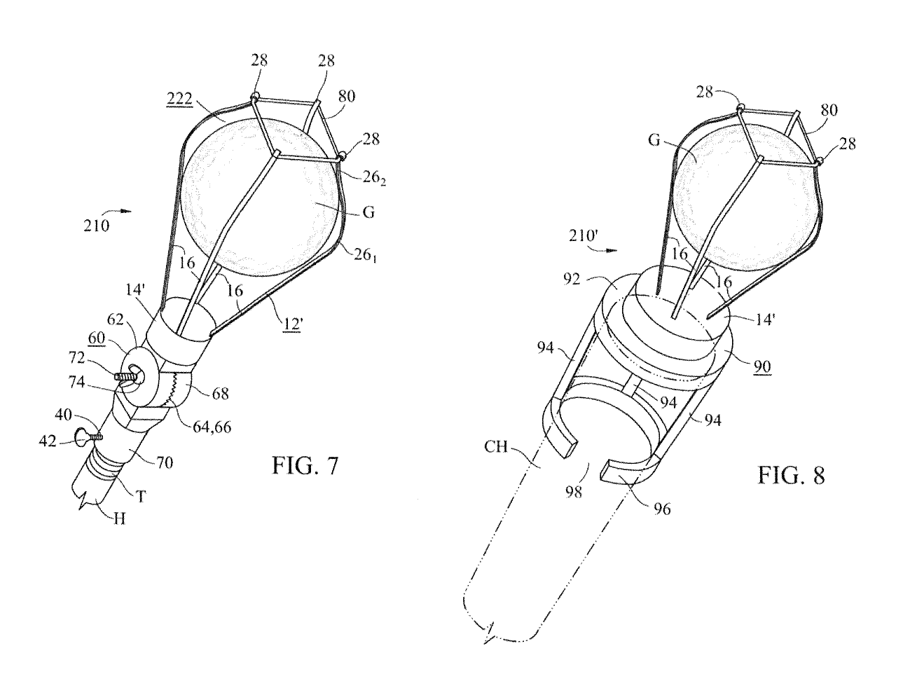

FIG. 2B shows the device 10 with a floodlight FL in place within the space 22. While the fingers 16 cannot be made to conform exactly to all objects of different shapes, such as a standard incandescent bulb like the light bulb IB in FIG. 2A and the floodlight FL in FIG. 2B, the mesh 30 will provide a sufficient frictional force on both of these disparately shaped objects sufficient to screw and unscrew them into and out of a light socket. As already noted, a device with the same general configuration as the device 10 can also be used to retrieve a golf ball (although other embodiments discussed further below are more readily adapted to such an application). As a golf ball retriever, the spacing between diagonally facing fingers 16 would preferably, although not necessarily, match the diameter of the golf ball, and the device would typically use an adjustable mount as described in connection with the embodiment in FIG. 7. Thus, the only deformation required would be to expand the mesh 30 between adjacent fingers sufficient to permit the golf ball to pass into the space 22. The mesh at the distal ends of the fingers would then reassume the shape shown in FIG. 1, capturing the golf ball in the space 22 at the concave portions 26₁ of the fingers 16. In a golf ball retriever configuration, the top hem 34 on the mesh could be made more easily expandable, or even omitted, to permit passage of the golf ball into the space 22 with virtually no resistance. This would enable the ball to be retrieved even when it is not on a firm surface (such as in a water hazard). Open netting mesh would be particularly preferred this application of the device because it will allow water to drain easily from the device when retrieving a ball in a water hazard. Rubber netting would also dry more readily than a fabric mesh. As already noted, those skilled in the art will easily envision other uses in which any object, particularly of a spheroid shape, could be placed and or retrieved using the device as described or such a device with minimal modification.

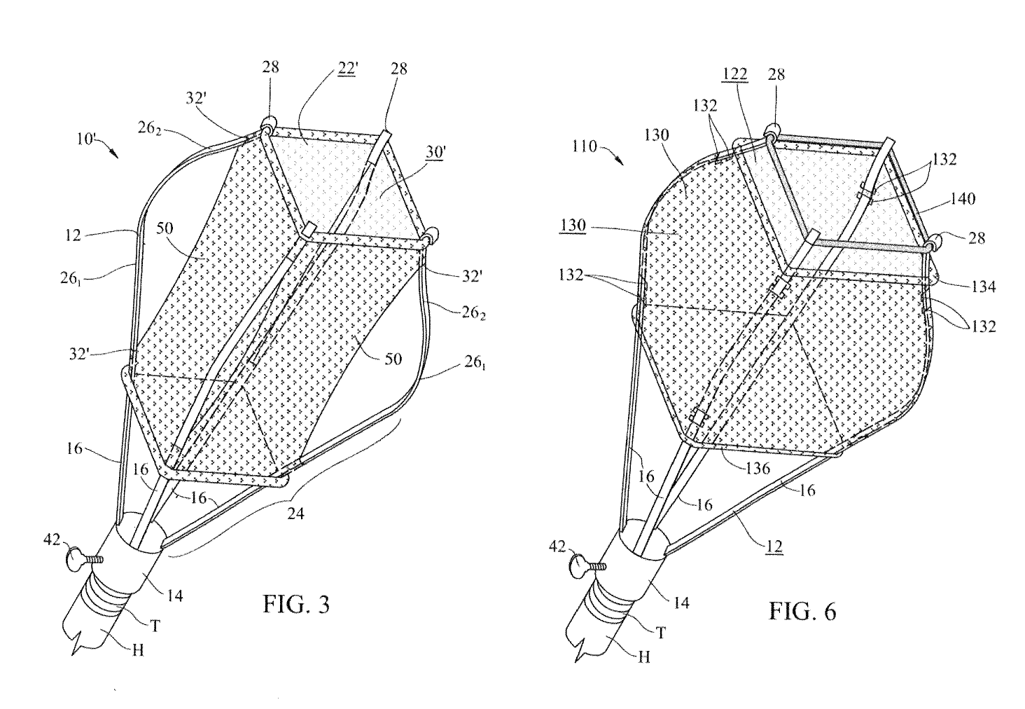

FIG. 3 illustrates the mesh enclosure in an alternate embodiment 30′. Otherwise, the device is the same as that shown in FIGS. 1, 2A, and 2B. That is, the fingers 16 are identical to those in the device 10, and the FIG. 3 device has the same base 14 configuration as in FIGS. 1, 2A and 2B. As with the mesh enclosure 30 of the previous embodiment, the alternate embodiment of the mesh enclosure 30′ has the shape shown in FIG. 3 when it is not mounted to the fingers 16. In other words, the internal space 22′ includes inwardly curved surfaces 50 between the fingers 16 that will be expanded more than the surfaces of the mesh 30 in the previous embodiment when an object such as a light bulb is in place within the space 22′. As a result, the mesh 30′ of this embodiment provides a greater frictional force on the bulb surface to assist in screwing it into and out of a light socket. It will also enable the device to be used more readily with smaller or odd-shaped bulbs, such as compact fluorescent bulbs. The mesh enclosure 30′ can be used to place/retrieve all of the same types of objects as the previous embodiment, with the advantages discussed here. As in the embodiment shown in FIG. 1, the fingers 16 shown in FIG. 3 are evenly spaced in a circumferential direction, so that if there are four fingers, as in the embodiment shown in FIG. 1, the fingers are at 90° relative locations around the periphery of the space 22. The number and relative spacing of the fingers is optional, although the device will typically include at least four fingers.

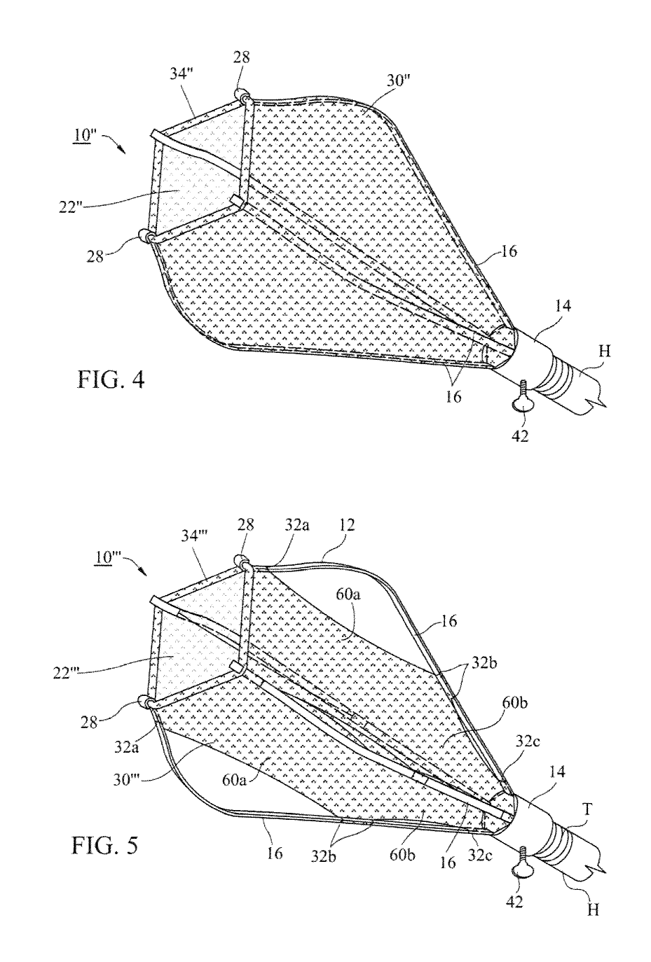

The embodiments of FIGS. 4 and 5 also use the frame 12 described in connection with the previous embodiments shown in FIGS. 1, 2 and 3. The FIG. 4 embodiment uses a mesh enclosure 30″ that extends all the way to the base 14 to form a space 22″ that encloses the entire volume between the fingers 16. As with the mesh enclosures 30 and 30″ of the previous embodiments, the mesh enclosure 30″ has the shape shown in FIG. 4 when it is not mounted to the fingers 16. The mesh 30″ is attached to the fingers 16 in any suitable fashion, such as cooperating Velcro® strips adhered to the fingers and sewn into or otherwise attached to the mesh. At the bottom, proximate to the base 14, the mesh enclosure can be attached to the fingers 16, the base 14, or both, in the same fashion. This embodiment enables the device to used more readily with more, different shaped objects than the previous embodiments. For example, the FIG. 4 embodiment will function similarly to the previous embodiments for bulbs such as the incandescent bulb IB and the floodlight FL in FIGS. 2A and 2B, but will also be capable of use with other object shapes and sizes, such as oblong, tear-shaped, and flame-shaped light bulbs, or smaller bulbs, because extending the mesh 30″ further toward the base 14 provide additional surface area for gripping such objects. The mesh enclosure 30″ can also be used to place/retrieve all of the same types of objects as the previous embodiment, and would be particularly useful with elongated fruits or vegetables, for example. Again, the number and spacing of the fingers can vary as described above in connection with the embodiments of FIGS. 1 and 3.

FIG. 5 depicts a variation of the FIG. 4 embodiment, with a mesh enclosure 30′″ that provides an internal space 22′″ with multiple inwardly curved surfaces for enhancing the gripping power of the mesh. As with the previously described mesh enclosures, the mesh enclosure 30′″ has the shape shown in FIG. 5 when it is not mounted to the fingers 16. To that end, the mesh 30′″ has a first set of slits 32a proximate to the top hem 34′″, a second set of slits 32b intermediate the top and bottom of the mesh, and a third set of silts 32c proximate to the bottom of the mesh at the base 14. The slits 32a, 32b, and 32c permit the mesh 30′″ to be mounted to the fingers 15 to present inwardly upper curved surfaces 60a, between the first and second sets of slits 32a and 32b, and lower inwardly curved surfaces 60b between the second and third sets of slits 32b and 32c. Thus, as with the FIG. 3 embodiment, the surfaces 60a and 60b between the fingers 16 will be expanded more than the surfaces of the mesh 30″ in the FIG. 4 embodiment when an object such as a light bulb is in place within the space 22′″. Accordingly, the mesh 30′″ provides a greater frictional force on the bulb surface of conventional bulb shapes, as well as odd-shaped and smaller bulbs, to assist in screwing them into and out of light sockets, as well as all of the other objects with which the embodiments in FIGS. 1 to 4 can be used.

FIG. 6 shows yet another variation of the device shown in the previous figures. FIG. 6 uses the same reference numerals as the previous embodiments for similar features, except that they have a “1” preceding them. In other words, the device 110 generally corresponds to the device 10 depicted and described above, with the same features, except where explicitly stated otherwise in this description or as will be apparent as the description proceeds. As with the other embodiments already described, the use of similar or identical reference numerals does not necessarily imply that the invention is limited to only one size of device. One of the advantages of the devices described here that embody the multiple use aspect of the invention is that one size of device can be used with objects of different sizes and shapes. However, it will be appreciated that generally a single device will be suitable for objects within a given size range, and objects within larger and smaller size ranges may require larger or smaller versions of the devices described herein. In that regard, the FIG. 6 embodiment is particularly useful for large objects. To that end it incorporates an elastic member including a mesh enclosure 130 in which the top hem 134 is secured to the fingers at a location spaced from the top distal end of the frame 12 (between the distal end and bowed portion of the fingers) so that it presents a larger opening to an object being inserted into the internal space 122 formed by the mesh 130. As with the mesh enclosure 30 of the previous embodiment, the mesh 130 has essentially the same shape shown in FIG. 6 when it is not mounted to the fingers 16. In addition, the elastic member also includes an elastic band 140 mounted in the hooks 28 at the distal end of each finger 16. The band 140 has the same length when it is not mounted within the hooks 28, so that it places no inward force on the fingers when no object is within the space 122. The elastic band 140 can take any suitable form, such as a conventional rubber band or even a coil spring.

The device 110 is suited to large objects because they slip more easily past the narrow expanse of elastic band 140 than they would through an opening at the top of the frame formed by the hem 134, as in the previously described embodiments, where they would immediately be gripped by the internal surface of the mesh. This is particularly the case if the internal surface of the mesh 130 is treated in a way to enhance the frictional force applied to the surface of say, a light bulb, within the space 122. Then, when the object is in its final position, the band 140 assists in gripping the bulb, since the bulb neck will expand the band in a fashion similar to the manner in which the necks of the bulbs IB and FL expand the top hem 34 of the enclosure 30 as seen in FIGS. 2A and 2B. Of course, the device could also be used with smaller bulbs, as well. The effect is to permit a single size device to accommodate a larger range of bulbs than would otherwise be the case, and further enhance its versatility.

Variations of this multi-use embodiment of the invention other than those specifically depicted in FIGS. 1 to 6 are possible within the scope of the invention. For example, the embodiments shown in FIGS. 3 to 5 can be adapted to include a band such as the band 140 included in the FIG. 6 embodiment. Those skilled in the art will recognize other variations and modifications besides those described.

### Sports Ball Holder/Retriever

FIG. 7 illustrates a variation of the device shown in the foregoing figures that is particularly adapted for use as a golf ball retriever. In this aspect of the invention the device 210 has four fingers 16 that are essentially the same as the fingers in the previous embodiment. As in the embodiments shown in FIGS. 1 to 6, the fingers are evenly spaced in a circumferential direction, so that if there are four fingers, as in the embodiment shown in FIG. 7, the fingers are at 90° relative locations. However, the number and relative spacing of the fingers is optional, and the device can include three or more fingers in different variations. The frame 12′ differs from the frame 12 in the previous embodiments principally in the configuration of the base. In this embodiment the base 14′ includes an integral adjustable mount 60 based on the swivel mount shown in U.S. Pat. No. 5,326,145, the disclosure of which is incorporated herein by reference. The mount 60 includes a disc 62 attached to the base 14′, the disc having a face 64 with radial grooves that mate with similar radial grooves in a face 66 of a disc 68 attached to a base extension 70. A threaded boss 72 attached, to the center of the disc 68 extends perpendicularly to its grooved face 66 through a central opening (not shown) in the disc 62 attached to the base 14. The threaded boss accepts a wing nut 74 that clamps the grooved faces 64 and 66 together to lock the adjustable mount 60 in a desired angular orientation relative to the frame 12.

The angular orientation can be changed by loosening the wing nut 74 and rotating the base extension 70 relative to the base 14′, and then retightening the wing nut. The base extension 70 has a threaded opening (not shown) extending axially into the base extension from the bottom to accept the external threads T at the distal end of the pole H, which will typically be similar to the pole H in the previously described embodiments. The base extension 70 includes a hole 40 extending radially from the outside circumferential surface of the base extension and into the axial opening that accepts the threads T on the end of the pole H. As with the previous embodiments, the thumbscrew 42 threads into the hole 40 so that the user of the device can tighten the internal end of the thumbscrew into contact with the pole H to prevent relative rotation of the base extension 70 and the pole H. In an alternate construction the base extension 70 and the pole H are an integral unit, and the telescoping construction of the pole enables the entire device to be shortened to a length that will fit conveniently in a golf hag with the golfer's clubs. In another alternate embodiment, the telescoping sections of the pole are not secured against relative axial rotation, since a ball retrieval operation typically does not require the ability to apply a significant amount of torque to the frame as part of retrieval operation, which is described just below. An elastic band 80 held by the hooks 28 at the distal end of each finger 16 completes the device 210.

Similar to the principle employed in previous embodiments, an elastic member comprising an elastic band 80, which can be a conventional rubber band, or a coil spring, or can even be made especially for the purpose, has the same length when it is not mounted within the hooks 28, so that it places no more than a minimal inward force on the fingers when the device is not in use. In addition, the fingers 16 of the device 210 are shaped and sized so that they enclose an internal space 222 that is just slightly larger in size and shape than a golf ball G (shown in FIG. 7 after it has been captured within the space 222). The elastic band 80 exerts minimal resistance to elongation so that the golf ball G can readily separate the distal ends of the fingers 16, especially considering the outwardly flared portion 26₂ of each finger. Once the fingers have been separated an amount sufficient for them to accept the ball G within the space 222, the ball passes the elastic band 80 and enters the space 222. In use a golfer can extend the pole H a sufficient distance to reach the golf ball G in a water hazard and push the elastic band 80 over the ball. This exerts very little force on the ball, but once it enters the space 222, the restoring force exerted by the elastic band 80 closes the fingers 16 around the ball and the ball is thus captured within the space 222 as shown in FIG. 7. To that end, the opening for the ball between the distal ends of the fingers need only be small enough to prevent the ball from passing back through the opening once it is within the space 222, thus further facilitating its entry into and capture by the space. Once the ball is thus captured, the golfer can retrieve it from the water hazard or other remote location.

FIG. 8 illustrates an adaption of the device shown in FIG. 7, in which the base of the device is constructed for removable attachment to golf club handle CH, shown in phantom lines in the drawing to facilitate depiction of the device 210′ in accordance with this embodiment. In essence the device 210′ is the same as the device 210 in the FIG. 7 embodiment except that it replaces the adjustable mount 60 with a golf adaptor 90 that fits over the club handle CH. The adaptor 90 includes an adaptor base 92 secured to the base 14′ and having integral depending struts 94 that hold an integral circular mounting bracket 96 with a gap 98. Typically, the base 14′ and the adaptor 90 are molded in one piece from a suitable plastic material chosen so that the struts can be deformed a sufficient amount to fit the bracket over the end of the club handle CH and then snap back to their original shape to firmly grip the dub handle and hold the device 210 in place. This embodiment can be used by a golfer who has difficulty bending over to pick up his or her ball. For example, it could be snapped onto a putter and used to retrieve the ball from the cup after holing out. It can also be used by able bodied golfers to pick up balls after a practice putting session. Other types of devices for this purpose often use suction cups to hold the ball, but the present invention provides a more positive engagement with the ball and prevents the ball from dislodging once it has been captured by the device.

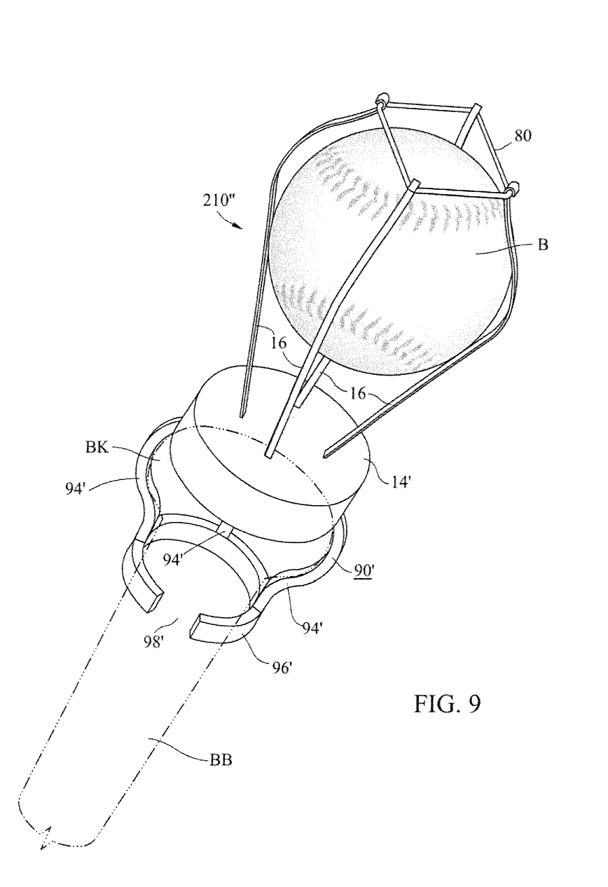

A retrieval device such as that in FIG. 8 can be applied to other sports ball retrieval situations in addition to golf balls. FIG. 9 illustrates yet another adaptation of a device with a frame like that in the previous figures sized for holding a baseball B and constructed for removable attachment to a baseball bat BB, shown in phantom lines in the drawing to facilitate depiction of the device 210″ in accordance with this embodiment. The baseball adaptor 90 generally corresponds to the golf adaptor 90 in the previous embodiment, except that the depending struts 94′ are shaped to fit over the knob BK at the end of the bat BB. This embodiment can be used for quickly picking up loose baseballs during or after a practice session, for example. Those skilled in the art will readily appreciate that a device in accordance with the present invention can be adapted to attach to other sports implements, such as a tennis racket or lacrosse stick, just to name a few. As before, there only needs to be at least three fingers.)

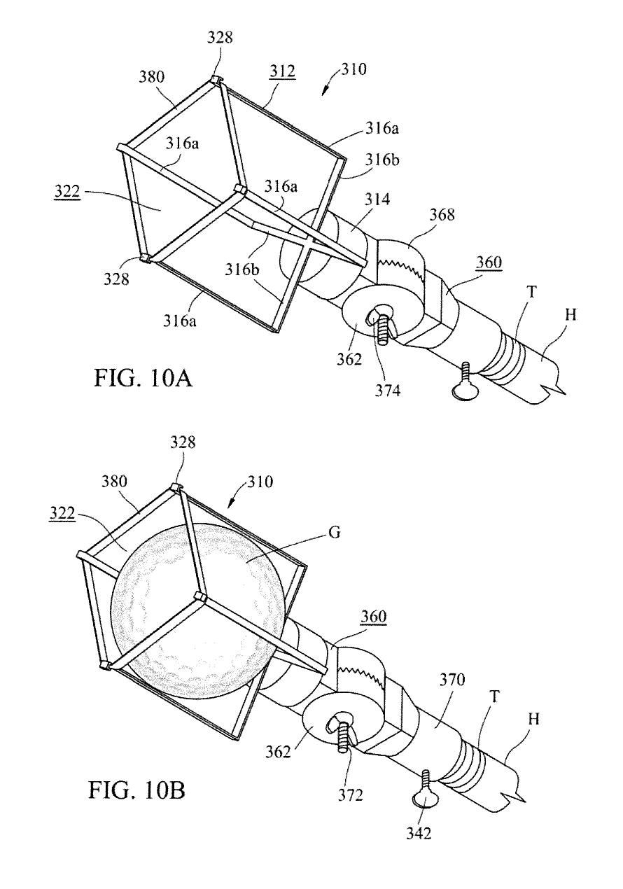

FIG. 10, comprising FIGS. 10A and 10B, shows another embodiment of the invention used for retrieving a golf ball. FIG. 10 uses the same reference numerals as the previous embodiments for similar features, except that they have a “3” preceding them. That is, the device 310 generally corresponds to the device 210 depicted and described above in connection with FIG. 7, except where explicitly stated otherwise in this description or as will be apparent as the description proceeds. In that regard, the device 310 includes a frame 312 that has a base 314, which includes an integral adjustable mount 360 constructed similarly to the adjustable mount 60 already described above in connection with FIG. 7. The adjustable mount 360 accepts threads on the end of the pole H, also as described above in connection with FIG. 7, or the mount 360 and the handle H can be a single unit. As with all of the embodiments, the number and spacing of the fingers can vary.

A principal difference between embodiments already described, such as that in FIG. 7, and the present embodiment resides in the configuration of the fingers that form the cage that captures the golf ball G. Each finger 316 of the present embodiment comprises a cage portion 316a and a base portion 316b. The base finger portions 316b are attached to the base 314 of the frame 312 and cross at right angles, and at the end of each base portion 316b a cage portion 316a extends upwardly at a right angle to form with the other cage portions an enclosure 322. The cage portions 316a are spaced apart so that the distance between diagonally opposing cage finger portions is only slightly larger than the diameter of the golf ball G, as illustrated in FIG. 10B showing the golf ball in place in the space 322. Hooks 328 at the distal ends of the cage finger portions 316a hold an elastic band 380 in place surrounding the periphery of the opening to the space 322. The elastic band 380, which can be a conventional rubber band or be made especially for the purpose, has essentially the same length when it is not mounted within the hooks 328, so that it places substantially no inward force on the fingers when not in use. Similar to the FIG. 7 embodiment, the elastic member, here the elastic band 380, exerts minimal resistance to elongation so that the golf ball G can readily expand the elastic band 380 and enter the space 322. Once the ball G is within the space 322, the portions of the elastic band 380 between the fingers 316a prevent it from escaping the space 322 so that it can be retrieved by the user. It will be appreciated that this embodiment provides even less resistance to entry of the golf ball into the space 380 than the embodiment shown in FIG. 7, and is thus even more advantageous in that regard. Those skilled in the art will recognize that the device shown in FIG. 10 can also be mounted to the end of a golf club in the same fashion as the embodiment shown in FIG. 8.

### Retrieving/Severing Device

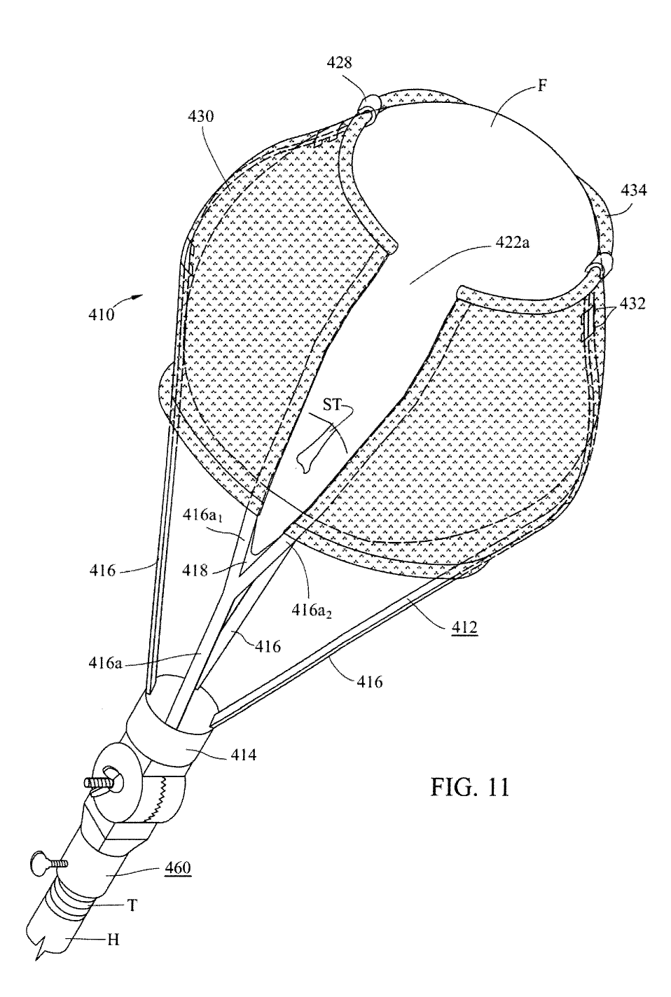

FIGS. 11 to 14 depict various embodiments that effect another aspect of the invention, in which a device akin to that shown in FIGS. 1 to 9 can be used to capture a remote object such as a fruit attached to a tree or vine and sever the stem of the fruit so that it can be retrieved. FIGS. 11 to 14 use the same reference numerals as the previous embodiments for similar features, except that they have a “4” preceding them. Thus, the device 410 generally corresponds to the device 10, 110, and 210 depicted and described above, except where explicitly stated otherwise in this description or as will be apparent as the description proceeds. In that regard, the device 410 includes a frame 412 that has a base 414, which includes an integral adjustable mount 460 constructed similarly to the adjustable mount 60 already described above. All of the features of the present embodiment are not described in detail since it will be clear from the drawings how the device 410 is constructed from the descriptions of the other embodiments already described. A principal difference between this embodiment and embodiments already described and depicted, such as the device in FIG. 1, is that one of the fingers 416 is bifurcated into a first finger part 416a₁ and a second finger part 416a₂. The device 410 is pressed onto a fruit F attached to a tree or vine in a similar fashion to the way the device 10 in FIG. 10 is used to grip a light bulb as shown and described in connection with FIGS. 2A and 2B. A mesh enclosure 430 in the present embodiment has edges 430₁ and 430₂ that attach to the finger parts 416a₁ and 416a₂. As in the previous embodiments, the mesh enclosure 430 has little or no tension exerted on it by the fingers or finger parts, which accordingly have substantially no inward force exerted on them. Together the finger parts and the resulting gap at the top of the mesh form a channel 422a that accepts a stem ST of the fruit F as the device 410 is pressed onto the fruit F, just like the device 10 is pressed onto the light bulb IB in FIG. 2A, for example. It will be appreciated that the distal ends of the fingers 416 can include hooks 428 for holding the top hem 434 of the mesh enclosure 430. The mesh 430 attaches to the finger parts 416a₁ and 416a₂ by Velcro® or in any other suitable manner as has already been discussed. Alternatively, the finger parts can have at their ends hooks like the hooks 428 at the ends of the fingers 416 and the mesh can have slots that accept the finger parts like the slots 432 that accept the fingers 416. As with the previous embodiments, there can be three or more fingers, with four being shown in FIG. 11 by way of example. And also as in the previous embodiments, the fingers need not be evenly spaced.

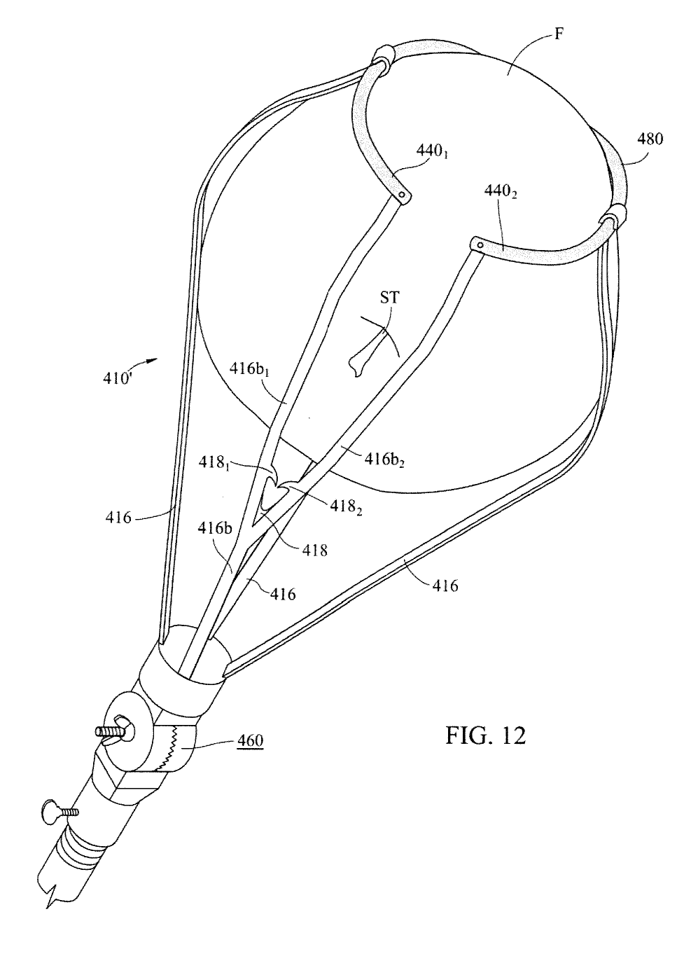

In use, the device 410 is positioned so that it can be pressed onto the fruit F with the stem ST entering in and traveling the length of the channel 422a. The first finger part 416a₁ and the second finger part 416a₂ form a “V” where they meet, and a cutting blade 418 is formed by sharp edges on the finger parts at the V. With the fruit F captured by the device 410 as shown in FIG. 11, the user manipulates the device to push the cutting blade 418 into the stem ST to sever the stem and free the fruit from the tree or vine. The user can thus harvest the fruit captured by the device. This embodiment is also particularly useful for retrieving or placing Christmas ornaments, since the hook for hanging the ornament on the tree will fit in between the first finger part 416a₁ and the second finger part. 416a₂, which will facilitate capture of the ornament in the internal space formed by the fingers 416. In a device specifically adapted for retrieving/placing Christmas ornaments, the blade 418 will typically be omitted. In addition, the mesh 430 can assume shapes similar to the shapes shown in FIGS. 3 to 5, or a separate band similar to the band 140 shown in FIG. 6 could also be incorporated into the basic configuration shown in FIG. 11. In another variation, the mount 460 and the handle H can be an integral unit, which is the case as well in the embodiments described in connection with FIG. 12-14 below.

FIG. 12 shows a device 410′ that represents a variation on the device 410 depicted in FIG. 11. That is, instead of the mesh enclosure 430 in FIG. 11, the device 410′ in FIG. 12 has an elastic band 480 at the distal ends of the fingers 416. The first and second finger parts 416b₁ and 416b₂ are also slightly different in that they not only include the cutting blade 418 but also have a pair of hooks 418₁ and 418₂ between which the stem ST must pass to reach the cutting blade 418. The elastic band is securely connected to the distal ends of the finger parts 416b₁ and 416b₂ by rivets 440₁ and 440₂, although other fastening arrangements may be used to the same purpose. As before, the band 480 is not held in tension by the fingers or finger parts, which accordingly do not have any inward force exerted on them. It will be appreciated that the fruit F is retrieved using the device in FIG. 12 in fashion similar to that described in connection with FIG. 11. The hooks 418₁ and 418₂ capture the stem ST make it easier for the user to sever it by maintaining it in close proximity to the cutting blade 418 as the user manipulates the device to press the cutting blade against the stem.

Variations in the configuration shown in FIG. 12 are also possible. For example, the hooks 418₁ and 418₂ on the fingers parts 416b₁ and 416b₂ can be located closer or farther from the “V” where finger parts meet than is depicted in FIG. 12. In addition, the blade 418 can be extended for a predetermined distance along the inside of one or both of the finger parts to provide an elongated cutting blade to facilitate severing of the stem ST from the remote location where the user is positioned. Likewise, the position of the hooks 418₁ and 412₂ is optional, and more than one set of hooks can be provided to further increase the utility of the device. And, as with all previous embodiments, the number and spacing of the fingers can vary according to the particular application of the device.

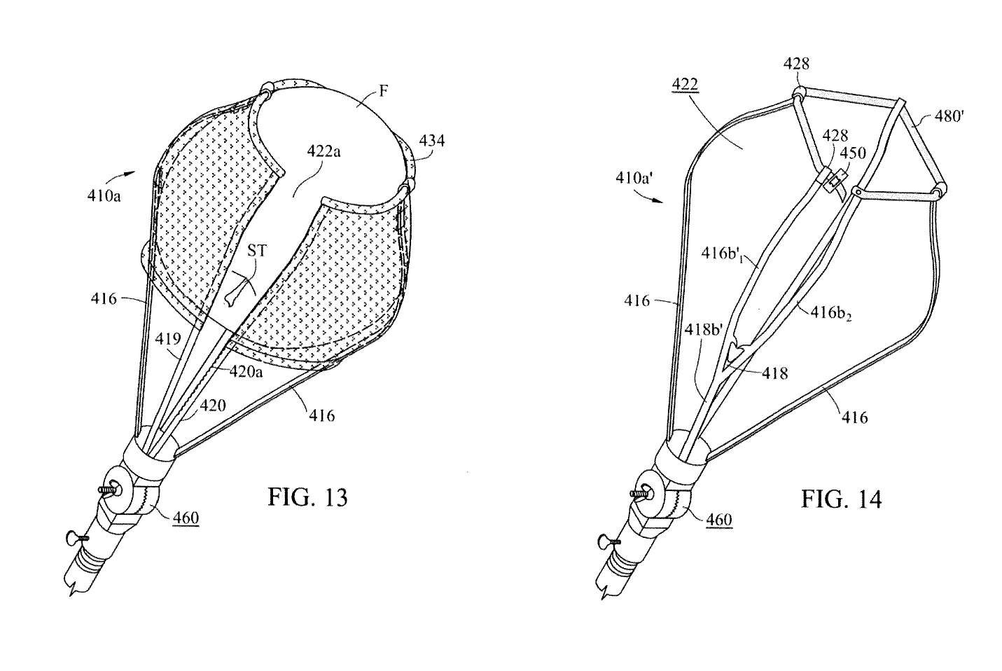

FIG. 13 illustrates a device 410a that is another variation on the device 410 described in connection with FIG. 11. It has like parts, except that the channel 422a is formed by two finger parts 419 and 420 that replace the bifurcated finger 416a. Moreover, the severing device is a saw blade 420a on the finger part 420 instead of the cutting blade 418 in the FIG. 11 embodiment. This embodiment is used similarly to the embodiments described above with a cutting blade, except that the device 410a is manipulated so that the stem is severed by drawing it across the saw blade 420a. This provides a more advantageous way of severing thicker fruit stems than a blade such as the cutting blade 418. Severing the stem can be facilitated even further by providing a saw blade on the finger part 419 as well as on the finger part 420. As before, the number of fingers is optional, with the number shown in FIG. 13 being only one example of the number of fingers 416 and the manner in which they are arranged. This embodiment could also include hooks similar to the hooks 418₁ and 418₂ shown in FIG. 12. The gap in the elastic mesh will further facilitate entry of the object to be retrieved into the space. This configuration is also well suited to retrieving a sports ball since the channel 422a between the finger parts 419 and 420 facilitates throwing the ball after it is picked up. For example, the device could be used in a game of fetch with a dog in which a ball is picked up from the ground after the dog retrieves it and is thrown again without removing it from the device. The presence of the channel would cause the device to more readily release the ball to enable it to be thrown. In an embodiment adapted for this purpose the cutting blade/saw would typically be omitted. A similar use would be in retrieving tennis balls after a practice session, or fruit that has fallen to the ground, and tossing them into a larger receptacle for storage. In addition, the devices could be used in a game of catch, because the channel 422a facilitates both throwing and catching in a manner similar to lacrosse. It will be appreciated that these applications are also possible with the embodiment shown in FIG. 12.

FIG. 14 illustrates a device 410a′ that is essentially a variation on the device 410′ described in connection with FIG. 12. A principal difference in the two embodiments is that the length of the elastic band 480′ in the device 410a′ is adjustable using the sliding tab 450. Accordingly, in the FIG. 14 embodiment, the band 480′ can be shortened and lengthened to adjust the size of the opening into the space 422 through which the fruit (not shown in FIG. 14) must pass. This feature makes the device more versatile, since the user can vary the size of the space 422 to adapt to different size fruits and vegetables.

### Collapsible Holding Device

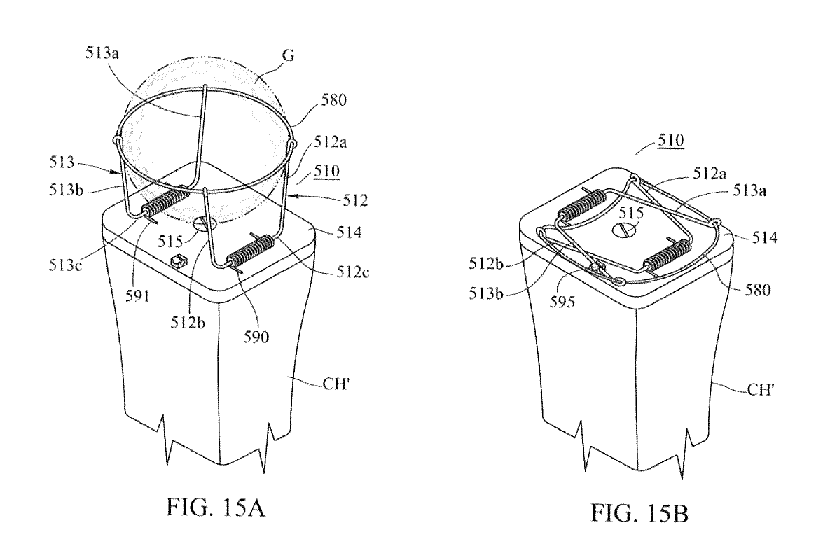

FIGS. 15A and 158 show an embodiment incorporating principles of the present invention in which a collapsible device can be attached to a sports implement such as a golf putter. FIG. 15A shows the collapsible device 510 in a deployed position holding a golf ball G (shown in phantom in the drawing to better depict the features of the device). The device includes a first frame member 512 that has two struts 512a and 512b attached at their proximal ends to a mounting portion 512c, and a second frame member 513 that has two struts 513a and 513b attached at proximal ends to a mounting portion 513c. The frame members 512 and 513 will preferably be made from wire stock and bent into the shape shown in the drawing. The mounting portions 512 and 513 are pivotably mounted to a base 514 and are biased into the deployed position shown in FIG. 15A by respective spring-biased hinges 590 and 591. As the drawing shows, when the frame members are in the deployed position the struts provide an internal space for accepting a portion of the golf ball G, with the distal ends of the struts defining an opening for accepting the ball. An elastic hand 580 is attached to the distal ends of the struts and is held in slight tension by the torsion springs, thereby positively retaining the ball when it has entered the opening a sufficient distance. Opposing pairs of the struts, that is, the struts 512a, 513b and the struts 512b, 513a, will typically be spaced a distance just slightly smaller than the diameter of the ball G, and the distal ends of the struts will be substantially evenly spaced around the opening. This causes the opening to expand as the ball enters and strengthens the grip of the elastic band 580 on the ball.

The base 514 will typically have the same shape as the end of the golf club handle CH′ and is secured to the end of the handle by an attachment screw 515. In a variation, the base can be formed by the end of the golf club handle itself. The device is particularly useful when applied to a putter handle, where it can be used by a golfer to retrieve his or her ball from the cup after holing out. This will be advantageous particularly for older golfers or golfers who may be physically impaired in a way that makes it difficult to bend down far enough to retrieve the ball from the cup.

FIG. 15B shows the device 580 in the stowed position, with the strut 513b removably secured in a restraining clip 595. The retaining clip can take any suitable form, but is depicted here as a small metal spring clip that deforms slightly to accept the strut 513b into a recess, and deforms to release the strut when the user pulls the strut upward out of the clip. The first frame member 512 is folded down first against the force of the spring 590 and the second frame member 513 is folded over the first frame member so that the struts 513a, 513b are on top of the struts 512a, 512b. As shown in FIG. 15B, the device in its stowed position fits wholly within the area of the end of the club handle CH′, and thus does not interfere with play when the club is being used.

In an alternate construction of this embodiment, the pivotal mounting of the frame members can be a hinge that is constructed to exert a frictional force against opening and closing in order to maintain the frame members in their deployed positions while accepting a ball into the opening. In another alternate construction the pivotal mounting could include a detent or other locking mechanism to maintain the frame members in their deployed positions. Those skilled in the art will be able to devise other constructions consistent with the intended uses of this aspect of the invention, and all such constructions are intended to be within the scope of the present invention.

### SUMMARY

While the above description mentions certain variations in the construction and operation of the gripper/retrieval/harvesting devices thus far described other variations are possible within the scope of the invention. Those skilled in the art will recognize that only selected preferred embodiments of the invention have been depicted and described, and it will be understood that various changes and modifications can be made other than those specifically mentioned above without departing from the spirit and scope of the invention, which is defined solely by the claims that follow.

What is claimed is:

1. A device for capturing an object comprising:
a base;
a plurality of resilient fingers extending from the base, the fingers being configured to provide an internal space for accepting therein at least a portion of the object, wherein the distal ends of the fingers define an opening configured to deflect the fingers outwardly to enlarge the opening when the object is passed therethrough; and
at least one elastic member attached between plural fingers, wherein the elastic member exerts substantially no inward force resisting expansion of the internal space until the fingers are deflected outwardly.

2. A device as in claim 1, wherein the device comprises four fingers substantially evenly spaced around the internal space.

3. A device as in claim 1, wherein:
the fingers each have a proximal end attached to the base and a distal end, the distal ends of the fingers being substantially evenly spaced around the space;
each of the fingers includes a portion between its proximal and distal ends that is bowed outwardly so that the cross sectional area of the opening is less than the cross sectional area of the space at the bowed portion of the fingers; and
the elastic member includes an elastic mesh enclosing the space at least at the bowed portion of the fingers, wherein the elastic mesh is expanded when the object is in the space for gripping the object.

4. A device as in claim 3, wherein the fingers are flared outwardly from a location proximate to the bowed portion to the distal ends.

5. A device as in claim 3, wherein the elastic mesh extends from the distal ends of the fingers to the base.

6. A device as in claim 3, wherein the elastic mesh extends around the bowed portions of the fingers on the outside thereof.

7. A device as in claim 3, wherein the elastic mesh comprises a generally tubular elastic mesh with one edge attached to the distal ends of the fingers and another edge attached to the fingers at a location between the bowed portion and the base.

8. A device as in claim 3, wherein the elastic member comprises:
an elastic band attached to and surrounding the opening at the distal ends of the fingers; and
a generally tubular elastic mesh with one edge attached to the fingers at a location between the distal ends of the fingers and the bowed portion and another edge attached to the fingers at a location between the bowed portion and the base.

9. A device as in claim 1, wherein the elastic member consists of an elastic band attached to and surrounding the opening at the distal ends of the fingers.

10. A device as in claim 1, wherein the base includes a mount for permitting a user adjust an angle formed between the base and a handle attached to the base.

11. A device as in claim 1, wherein:
the fingers each have a proximal end attached to the base and a distal end, the distal ends of the fingers being substantially evenly spaced around the space; and
one of the fingers comprises adjacent first and second finger parts to which the elastic member is attached to provide an open channel between the finger parts.

12. A device as in claim 11, wherein the finger parts comprise bifurcated portions of one of the fingers.

13. A device as in claim 12, wherein the bifurcated portions form a V-shaped notch terminating the channel and a cutting blade is disposed in the notch.

14. A device as in claim 11, wherein the finger parts are separate, having proximal ends attached to the base and distal ends to which the elastic member is attached, and at least one of the finger parts includes a saw blade extending along the finger part.

15. A device as in claim 11, wherein the elastic member includes an elastic mesh extending along at least at the bowed portion of the fingers and terminating at the finger parts to permit access to the channel between the finger parts.

16. A device as in claim 11, wherein the elastic member consists of an elastic band attached to the distal ends of the fingers and terminating at the finger parts to permit access to the channel between the finger parts.

17. A device as in claim 16, wherein the length of the elastic member is adjustable.

18. A device for capturing an object comprising:
a base;
a plurality of resilient fingers, each having a proximal end attached to the base and a distal end, the fingers defining an internal space with an opening formed by the distal ends of the fingers for permitting the object to enter the space, wherein each of the fingers includes a portion between its proximal and distal ends that is bowed outwardly so that the cross sectional area of the opening is less than the cross sectional area of the space at the bowed portion of the fingers, the fingers being deflected outwardly as the object passes through the opening and the internal space being configured to permit the fingers to resume their original shape when the object has passed the opening; and
at least one elastic member surrounding the opening at the distal ends of the fingers, wherein the elastic member exerts substantially no force on the fingers until the fingers are deflected outwardly.

19. A device as in claim 18, wherein the device comprises four fingers substantially evenly spaced around the internal space.

20. A device as in claim 19 for capturing a spherical object in the space, wherein:
the elastic member consists of an elastic band secured to the fingers at the distal ends thereof;
each of the fingers has a proximal end attached to the base and a distal end, the distal ends of the fingers being evenly spaced around the space; and
each of the fingers includes a portion between its proximal and distal ends that is bowed outwardly so that the cross sectional area of the space is at least as large as the diameter of the object.

21. A device as in claim 20, wherein the base includes a mount for permitting a user to adjust an angle formed between the base and a handle attached to the base.

22. A device as in claim 20, wherein the base includes a mount for removably attaching the base to the handle of a sports implement.

23. A device as in claim 22, wherein the sports implement is one of a golf club and a baseball bat.

24. A device for retrieving a golf ball, the device comprising:
a base including a mount for permitting a user to adjust an angle formed between the base and a handle attached to the base;
a plurality of fingers, each having a proximal end attached to the base and a distal end, the fingers defining an internal space with an opening formed by the distal ends of the fingers for permitting the golf ball to enter the space, wherein the fingers substantially retain their original shape as the golf ball passes through the opening and the internal space has a cross sectional area at least as large as the diameter of the golf ball; and
at least one unexpanded elastic member surrounding the opening at the distal ends of the fingers, wherein the elastic member expands as the golf ball passes through the opening and resumes its original unexpanded shape when the golf ball is within the space.

25. A device as in claim 24, wherein the device comprises four fingers substantially evenly spaced around the internal space.

26. A device as in claim 24, wherein the elastic member consists of an elastic band secured to the fingers at the distal ends thereof.

27. A collapsible device for capturing an object comprising:
a first frame member having at least two struts with proximal ends attached to a mounting portion with a space between the struts and a second frame member having at least two struts with proximal ends attached to a mounting portion with a space between the struts, the mounting portions being pivotably mountable to a base for rotation between a stowed position wherein the struts lie against the base and a deployed position wherein the struts extend upright from the base;
a first spring biasing the first frame member into the deployed position and a second spring biasing the second frame member into the deployed position, wherein when the frame members are in the deployed positions the struts provide an internal space for accepting therein at least a portion of the object and the distal ends of the struts define an opening for accepting the object;
at least one elastic member attached to the distal ends of the struts for retaining the object when the frame members are in the deployed positions; and
a retainer for releasably retaining the frame members in the stowed positions.

28. A device as in claim 27, wherein the object is a spherical sports ball and the distal ends of the struts are substantially evenly spaced around the opening when the frame members are in the deployed position.

29. A device as in claim 27, wherein the device includes the base with the frame members mounted thereto, the base including an attachment for securing the base to the end of a handle of a sports implement used with the sports ball and the base having thereon the retaining clip.

30. A device as in claim 29, wherein:
the retainer comprises a retaining clip for capturing one strut of one frame member to retain the one strut in the stowed position with the struts of the other frame member retained in the stowed position by the struts of the one frame member; and
the frame members in the stowed position do not extend beyond the area of the end of the end of the handle.

31. A device as in claim 30, wherein the sports ball is a golf ball and the sports implement is a putter, and wherein the golf ball only partially enters the internal space and is held in place in the device by the elastic band.
